(19) United States
(12) Patent Application Publication
(10) Pub. No.: US 2018/0230631 A1
(43) Pub. Date: Aug. 16, 2018

(54) PROCESS AND SYSTEM FOR FASTENING A FUNCTIONAL FLEXIBLE ELEMENT TO A FLEXIBLE SUPPORT BY ZIGZAG STITCHING

(71) Applicant: Airbus Operations SAS, Toulouse (FR)

(72) Inventors: Xavier LEGRAND, Villeneuve D'Ascq (FR); Bertrand DUTHILLE, REZE (FR)

(21) Appl. No.: 15/892,675

(22) Filed: Feb. 9, 2018

(30) Foreign Application Priority Data
Feb. 13, 2017 (FR) 1751161

(51) Int. Cl. D05B 3/12; D05B 17/00; D05B 19/14; B29C 65/02; B29C 65/62; B29C 65/00

(52) U.S. Cl. CPC D05B 3/12; D05B 17/00; B29C 66/7315; B29C 65/02; B29C 65/62; D05B 19/14

(57) ABSTRACT

A process for attaching a functional flexible element on a flexible support without the use of adhesive composition. The process comprises a step of depositing a functional flexible element on a flexible support, a step of stitching along a zigzag line of at least one binding yarn on either side of the functional flexible element along the functional flexible element while retaining the functional flexible element on the flexible support. The first binding yarn(s) are stitched into the flexible support at stitching points to a depth of less than the thickness of the flexible support.

### CROSS-REFERENCES TO RELATED APPLICATIONS

This application claims the benefit of the French patent application No. 1751161 filed on Feb. 13, 2017, the entire disclosures of which are incorporated herein by way of reference.

### TECHNICAL FIELD

The present invention relates to a process for fastening a functional flexible element to a flexible support.

The invention also relates to a system for fastening a functional flexible element to a flexible support.

### BACKGROUND OF THE INVENTION

The present invention lies in the technical field of devices for placing a functional flexible element, in particular a textile element, on at least one of the faces of a flexible support having a given thickness, in particular a textile reinforcement or a preimpregnated composite material, according to an orientation and a location that are predetermined so as to adjust, supplement and/or improve properties, such as the mechanical properties or else the esthetic properties, of the flexible support. A composite material is understood to mean any material comprising a textile reinforcement and a polymer matrix.

A technique exists that consists in precoating the functional flexible element with an adhesive composition before it is deposited on a face of the flexible support made of composite material. This technique has a drawback of using a composition that adheres both to the functional flexible element and to the composite material of the flexible support. Furthermore, the use of an adhesive composition necessitates that this adhesive composition can be recycled and complicates the technique for depositing the functional flexible element on the flexible support made of composite material.

### SUMMARY OF THE INVENTION

An objective of the present invention is to overcome these drawbacks by providing a process that avoids the use of an adhesive composition and can be used equally well on a flexible support such as a textile reinforcement or a preimpregnated composite material.

For this purpose, the invention relates to a process for fastening a functional flexible element to a flexible support, the functional flexible element having an elongated shape that has a width smaller than the length, the flexible support having a thickness.

According to the invention, the process comprises the following steps:

a step of depositing the functional flexible element on the flexible support;

a step of stitching along a first zigzag line of at least one first binding yarn at stitching points on either side of the functional flexible element along the functional flexible element while retaining the functional flexible element on the flexible support, the first binding yarn(s) being stitched into the flexible support at the stitching points to a depth of less than the thickness of the flexible support.

Thus, by means of the stitching step, the use of an adhesive composition is avoided. This process can be used equally well on a flexible support having a given thickness, such as a textile reinforcement or a preimpregnated composite material.

According to one variant, the process further comprises:

a supplementary step of stitching along a second zigzag line of at least one second binding yarn at stitching points on either side of the functional flexible element along the functional flexible element while retaining the functional flexible element on the flexible support, the second binding yarn(s) being stitched into the flexible support at the stitching points to a depth of less than the thickness of the flexible support.

According to one distinctive feature, the stitching points of the second binding yarn(s) are located so that a stitching point of the first binding yarn(s) on one side of the functional flexible element is located between two stitching points of the second binding yarn(s) on the same side of the functional flexible element, without counting the first and last stitching point of the second binding yarn(s).

According to another distinctive feature, the first binding yarn(s) and the second binding yarn(s) are stitched at a first distance relative to a first edge of the functional flexible element and at a second distance relative to a second edge of the functional flexible element.

According to a first embodiment, the step of stitching along the first zigzag line is carried out with a single first binding yarn.

According to a second embodiment, the step of stitching along the first zigzag line is carried out with a plurality of first binding yarns, the first zigzag line being formed of segments, a first binding yarn forming one segment being different from another first binding yarn forming an adjacent segment having a stitching point in common.

Furthermore, the supplementary step of stitching along the second zigzag line is carried out with a single second binding yarn.

In addition, the supplementary step of stitching along the second zigzag line is carried out with a plurality of second binding yarns, the second zigzag line being formed of segments, a second binding yarn forming one segment being different from another second binding yarn forming an adjacent segment having a stitching point in common.

Moreover, the process comprises a step of joining the first binding yarn(s) and the second binding yarn(s) that consists in joining the first binding yarn(s) and the second binding yarn(s) to the flexible support by polymerization or by melting.

The invention also relates to a system for fastening a functional flexible element to a flexible support, the functional flexible element having an elongated shape that has a width smaller than its length, the flexible support having a thickness.

According to the invention, the system comprises a first device for stitching at least one first binding yarn, the first stitching device comprising:

a needle comprising an eye through which the least one first binding yarn is able to pass,

a movement module for moving the needle configured to move and stitch the needle,

a control device configured to control the movement module so that the movement module stitches the needle into the flexible support along a first zigzag line of at least one binding yarn along the functional flexible element while retaining the functional flexible element, to a depth of less than the thickness of the flexible support.

Furthermore, the movement module comprises:

a sub-module for lowering the needle, configured to stitch the needle into the flexible support at a first stitching point to a depth of less than the thickness of the flexible support,

a sub-module for raising the needle, configured to raise the needle after having stitched the first binding yarn(s) into the flexible support,

a sub-module for translation of the needle, configured to convey the needle from the first stitching point to a second stitching point in order to form a zigzag segment.

Moreover, the movement module further comprises a rotational sub-module configured to rotate the needle about a predetermined angle of rotation around its longitudinal axis after the sub-module for raising the needle has raised the needle, the predetermined angle of rotation being substantially equal to an angle that corresponds to the angle between two successive zigzag segments having a stitching point in common.

According to a variant, the system comprises a second device for stitching at least one second binding yarn that is identical to the first stitching device.

### BRIEF DESCRIPTION OF THE DRAWINGS

The invention, with its features and advantages, will become more clearly apparent on reading the description given with reference to the appended drawings in which:

FIG. 1 represents a schematic top view of a functional flexible element fastened to a flexible support according to a first embodiment of the process,

FIG. 2 represents a cross section of the functional flexible element and of the flexible support,

FIG. 3 represents a schematic top view of a functional flexible element fastened to a flexible support according to a second embodiment of the process,

FIG. 4 represents the fastening system according to one embodiment,

FIG. 5 represents an overview diagram of the process for fastening a functional flexible element to a flexible support,

FIG. 6 represents a cross section of the functional flexible element and of the flexible support according to another embodiment.

### DETAILED DESCRIPTION OF THE PREFERRED EMBODIMENTS

The remainder of the description will refer to the abovementioned figures.

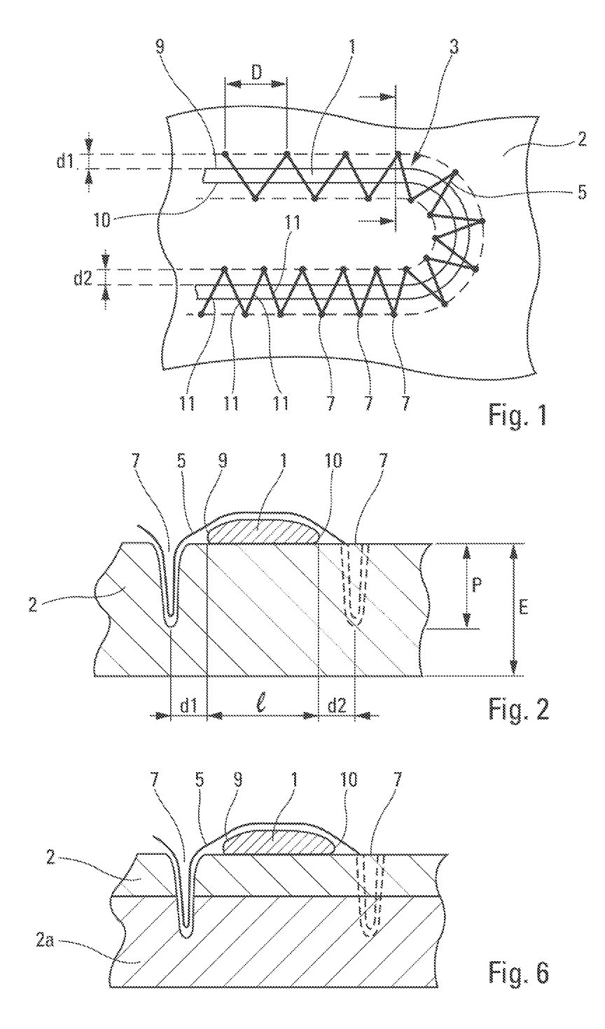

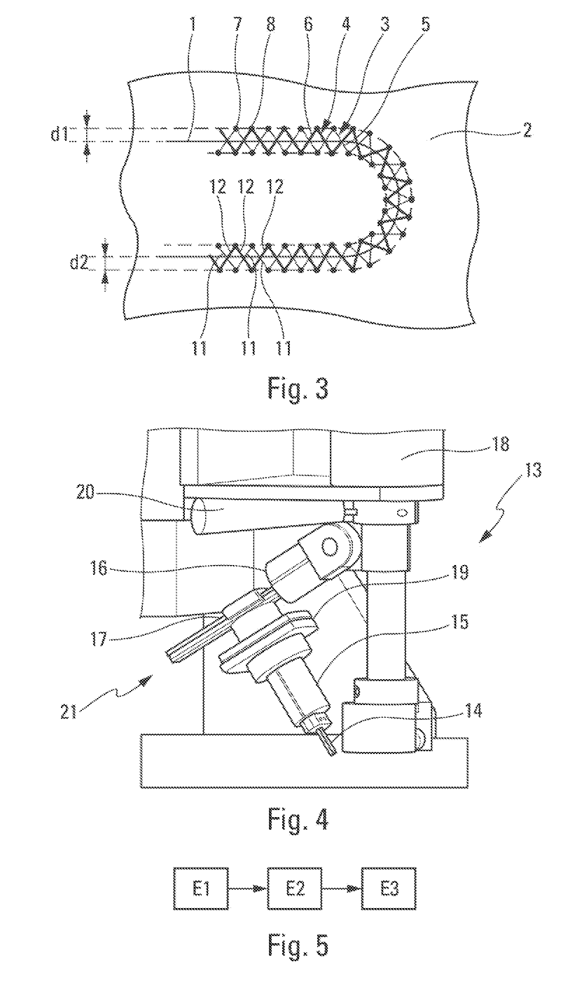

The invention relates to a process for fastening a functional flexible element 1 to a flexible support 2 (FIGS. 1 and 3).

The functional flexible element 1 has an elongated shape that has a width 1 smaller than its length. The flexible support 2 has, itself, a thickness E.

The process comprises the following steps (FIG. 5):

a step E1 of depositing the functional flexible element 1 on the flexible support 2;

a step E2 of stitching along a zigzag line 3 of at least one binding yarn 5 at stitching points 7 on either side of the functional flexible element 1 along the functional flexible element 1 while retaining the functional flexible element 1 on the flexible support 2.

The binding yarn(s) 5 are stitched into the flexible support 2 at the stitching points 7 to a depth P of less than the thickness E of the flexible support 2 (FIG. 2).

The stitching step is carried out using a needle 14.

The stitching step may also be carried out by additive manufacturing or 3D printing.

According to one variant (FIG. 3), the process further comprises a supplementary step E3 of stitching along a zigzag line 4 of at least one binding yarn 6 at stitching points 8 on either side of the functional flexible element 1 along the functional flexible element 1 while retaining the functional flexible element 1 on the flexible support 2. As for the binding yarn(s) 5, the binding yarn(s) 6 are stitched into the flexible support 2 at the stitching points 8 to a depth P of less than the thickness E of the flexible support 2.

Each of the zigzag lines 3, 4 is formed of segments 11, 12 placed end-to-end.

Preferably, the stitching points 8 of the binding yarn(s) 6 are located so that a stitching point 7 of the binding yarn(s) 5 on one side of the functional flexible element 1 is located between two stitching points 8 of the binding yarn(s) 6 on the same side of the functional flexible element 1, without counting the first and last stitching point of the binding yarn(s) 6.

Advantageously, the binding yarn(s) 5 and the binding yarn(s) 6 are stitched at a distance d1 relative to a longitudinal edge 9 of the functional flexible element 1 and at a distance d2 relative to an edge 10 of the functional flexible element 1.

According to a first embodiment of step E2, the step E2 of stitching along the zigzag line 3 is carried out with a single yarn 5.

According to a second embodiment of step E2, the step E2 of stitching along the zigzag line 3 is carried out with a plurality of yarns 5. A yarn 5 forming one segment 11 is a yarn different from another first yarn 5 forming an adjacent segment 11 having a stitching point 7 in common. This embodiment may be similar to a stapling of the functional flexible element 1 to the flexible support 2.

Similarly, according to a first embodiment of the supplementary step E3, the supplementary step E3 of stitching along the zigzag line 4 may be carried out with a single yarn 6.

According to a second embodiment of the supplementary step E3, the supplementary step E3 of stitching along the zigzag line 4 is carried out with a plurality of second yarns 6. A yarn 6 forming a segment 12 is a yarn different from another yarn 6 forming an adjacent segment 12 having a stitching point 8 in common.

An embodiment of the step E2 may be combined with any one of the embodiments of the supplementary step E3.

In the stitching steps E2 and E3, the binding yarn(s) 5, 6 pass over the functional flexible element 1 between two successive stitching points 7, 8 so that the functional flexible element 1 is retained on the flexible element 2 by being held between the binding yarn(s) 5, 6 and the flexible support 2.

According to one variant, the process comprises a step E4 of joining the binding yarn(s) 5 and the binding yarn(s) 6 that comprises joining the binding yarn(s) 5 and the binding yarn(s) 6 to the flexible support 2 by polymerization or by melting.

According to one embodiment, the step E4 of joining the binding yarn(s) 5 and the binding yarn(s) 6 consists in joining the binding yarn(s) 5 and the binding yarn(s) 6 to the flexible support 2 by embroidery.

The flexible support 2 is flexible enough so that it can be pierced by the needle 14. The face(s) of the flexible support 2 on which the functional flexible element 1 is deposited may be flat or presented with reliefs. If the flexible support 2 is not thick enough to be stitched without being completely pierced through, it is possible to provide a supplementary layer 2a along the face of the flexible support 2 opposite the one receiving the stitching (FIG. 6). This layer 2a may be made of a foam or a nonwoven, and it is preferably manufactured from a fusible polymer material, in particular having a melting point above or equal to the temperature required for the polymerization of the polymer matrix of the finished composite material comprising the flexible support 2.

The functional flexible element 1 may comprise one or more multifilament yarns or yarns spun from fibers assembled by weaving, braiding or knitting or arranged parallel to one another in the form of a roving. The functional flexible element 1 has, by definition, a length much greater than its width 1. The functional flexible element 1 generally carries out the role of reinforcement in the flexible support 2. According to the results of mathematical models, the functional flexible element 1 is arranged according to a predetermined orientation on a flexible support 2 acting as a ply so as to improve the final mechanical performance of the composite material formed of the ply or comprising the ply.

The functional flexible element 1 may be an optical fiber or a heating fiber. The functionality provided to the flexible support 2 by the functional flexible element 1 is dependent on the mechanical, physical and chemical performance of the latter.

The functional flexible element 1 may be manufactured from a natural textile material (for example cellulose), a regenerated textile material (for example viscose) or a synthetic textile material. Preferably, the functional flexible element 1 is made of a synthetic material (polyester, polyamide, polypropylene, polyethylene), preferably based on carbon, glass or ceramic. The functional flexible element 1 may also be a high-performance yarn, that is to say, a yarn having a tenacity markedly greater than 60 cN/tex. Preferably in the latter case, the functional flexible element 1 is chosen from the following polymer families, alone or as a blend: aromatic polyamides such as para-aramid (poly-p-phenylene terephthalamide), meta-aramid (poly-m-phenylene isophthalamide), and copolymers of para-aramids; aromatic polyimides; high-performance polyesters, high-density polyethylene (HDPE); polybenzoxazoles such as PBO (p-phenylene benzobisoxazole) and PIPD (polypyridobisimidazole); polybenzothiazoles.

The binding yarn(s) 5, 6 may be manufactured from a natural textile material (for example cellulose), a regenerated textile material (for example viscose) or a synthetic textile material. The binding yarn(s) 5, 6 are preferably manufactured from a synthetic material, in particular chosen from one of the following polymer families: polyethylene terephthalate (polyester), polyamide, polyethylene, polypropylene.

When the flexible support 2 is a textile reinforcement or a preimpregnated composite material, the binding yarn(s) 5, 6 are advantageously chosen so that it is partially or completely based on a polymer having a melting point above or equal to the polymerization temperature required for the polymerization of the polymer matrix of the textile reinforcement or of the composite material.

Thus, the binding yarn(s) 5, 6 carry out their role of holding the functional flexible element 1 in a predetermined orientation on at least one of the faces of the flexible support 2, thus enabling the flexible support 2 to be used as a ply, then are melted so as not to impair the mechanical performance of the flexible support 2. Preferably, the binding yarn(s) 5, 6 are manufactured from the same polymer material as that forming the matrix of the finished composite material of the flexible support 2.

The process described above is carried out by a system for fastening a functional flexible element 1 to a flexible support 2.

The system comprises a device 13 for stitching at least one binding yarn 5 (FIG. 4).

The stitching device 13 comprises:

a needle 14 comprising an eye through which at least one first binding yarn 5 is able to pass,

a movement module 21 for moving the needle 14 configured to move and stitch the needle 14,

a control device 18 configured to control the movement module 21 so that the movement module 21 stitches the needle 14 into the flexible support 2 along a zigzag line 3 of at least one binding yarn 5 along the functional flexible element 1 while retaining the functional flexible element 1, to a depth P of less than the thickness E of the flexible support 2.

For example, the eye of the needle 14 is located at a free end of the needle 14.

The needle 14 of the stitching device 13 may be removable.

Advantageously, the movement module 21 comprises:

a sub-module 15 for lowering the needle 14, configured to stitch the needle 14 into the flexible support 2 at a first stitching point 7 to a depth P of less than the thickness E of the flexible support 2,

a sub-module 16 for raising the needle 14, configured to raise the needle 14 after having stitched the binding yarn(s) 5 into the flexible support 2,

a sub-module 17 for translation of the needle 14, configured to convey the needle 14 from the first stitching point 7 to a second stitching point 7 in order to form a zigzag segment 11.

The movement module 21 further comprises a rotational sub-module 19 configured to rotate the needle 14 about a predetermined angle of rotation around its longitudinal axis after the sub-module 16 for raising the needle has raised the needle 14. The predetermined angle of rotation is substantially equal to an angle that corresponds to the angle between two successive zigzag segments 11 having a stitching point 7, 8 in common.

The needle 14 is optionally guided by a tube.

The tube prevents the buckling of the needle 14 depending on the stiffness and the thickness of the flexible support 2. This needle 14 stitches on either side of the functional flexible element 1 and this being in the longitudinal direction of the element 1. The binding yarn(s) 5, 6 thus penetrate to a given depth P in the thickness E of the flexible support 2 and this being alternately along the two longitudinal edges 9, 10 of the functional flexible element 1. This stitching technique advantageously makes it possible to considerably reduce the stitching density and therefore the number of perforations created in the structure of the flexible support 2 and also the length of the binding yarn(s) 5, 6 absorbed relative to the embroidery technique. The detrimental effects of the binding yarn(s) 5, 6 on the mechanical performance of the composite material as known from the prior art are thus reduced or even completely eliminated.

The stitching device 13 may comprise a spool module that makes it possible to receive at least one spool 20 of binding yarns 5, 6.

Advantageously, the binding yarn(s) 5, 6 are not caught on a platform positioned on the opposite face of the flexible support 2 to the one that is stitched first, then optionally tied. The binding yarn(s) 5, 6 are held by the flexible support 2 gripping it in the stitching cavity formed. Preferably, the binding yarn(s) 5, 6 do not move back up with the removal of the needle 14 from the flexible support 2, but form a loop in the stitching cavity.

Depending on the stitching speed, the spacing D between two stitching points 7, 8, corresponding to two entries of the binding yarn(s) 5, 6 into the flexible support 2, is bigger or smaller. Preferably, the stitching is carried out on either side and at a predetermined distance d1, d2 from each longitudinal edge 9, 10 of the functional flexible element 1.

According to one variant, the system comprises a second device for stitching at least one second binding yarn 6 identical to the stitching device 13 described above.

The second stitching device is configured so that the stitching points 8 of the binding yarn(s) 6 are located so that a stitching point 7 of the binding yarn(s) 5 is located between two stitching points 8 of the binding yarn(s) 6, without counting the first and last stitching point of the binding yarn(s) 6.

The remainder of the description presents a nonlimiting exemplary embodiment.

The flexible support 2 represented in FIGS. 1 to 3 and 6 is mechanically reinforced by the placement of a functional flexible element 1 along a determined orientation on the upper face of the support 2. The flexible support 2 is in this precise example a textile reinforcement composed of one or more plies. The functional flexible element 1 is a reinforcing element composed of a roving of carbon fibers of 12K having a width of 5 mm. The functional flexible element 1 is held with the aid of a binding yarn 5 stitched into the thickness of the flexible support 2 to a depth P, less than the total thickness E of the flexible support 2 so that the binding yarn 5 is not found on the lower face of the support 2. In this precise case, the stitching is carried out using a single needle 14 through which the binding yarn 5 passes. The binding yarn 5 thus forms a zigzag stitch, stitching on either side of the functional flexible element 1 and at identical determined distances d1, d2 from each of its longitudinal edges 9, 10. The distances d1 and d2 are greater than 1 mm, preferably d1 and d2 are of the order of 7 mm. The binding yarn 5 passes over the functional flexible element 1 (as is visible in FIG. 2), so that the functional flexible element 1 is pinned to the upper face of the flexible support 2. The binding yarn 5 forms a loop in the stitching cavity 7 formed by the needle 14. The amount of binding yarn 5 used to hold the functional flexible element 1 and also the density of stitching cavities formed by the needle 14 are much lower than those observed for the embroidery technique so that the binding yarn(s) 5 exert little or even no detrimental effect on the mechanical performance resulting from the interaction between the flexible support 2 and the functional flexible element 1. The binding yarn(s) 5, 6 are preferably fusible so as to become embedded in the polymer matrix provided or formed subsequently.

The second example differs from the previous example in that the functional flexible element 1 is held on the upper face of the flexible support 2 with the aid of two binding yarns 5, 6, thus forming a “W” stitch. In this case, two needles 14 are needed, each receiving a binding yarn 5, 6. The means for moving the needles 14 are identical. The head that receives the needles 14 thus follows, for each “W” pattern, the following four movements: a clockwise rotation of 180°, a linear movement toward the upper face of the flexible support 2, a rotation of 180° in the trigonometric direction then a linear movement in a direction opposite to the upper face of the flexible support 2. The use of two needles and of rotational means makes it possible to carry out either the zigzag stitch (a single needle 14 is then used), or the “W” stitch (the two needles 14 are used).

Modules for cutting and for inserting a new binding yarn for each stitching needle (not represented) may also be necessary for the implementation of the process.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A process for fastening a functional flexible element to a flexible support, the functional flexible element having an elongated shape that has a width smaller than its length, the flexible support having a thickness,
wherein the process comprises the following steps:
a step of depositing the functional flexible element on the flexible support;
a step of stitching along a first zigzag line of at least one first binding yarn at stitching points on either side of the functional flexible element along the functional flexible element while retaining the functional flexible element on the flexible support, the at least one first binding yarn being stitched into the flexible support at the stitching points to a depth of less than a thickness of the flexible support.

2. The process as claimed in claim 1, further comprising:
a supplementary step of stitching along a second zigzag line of at least one second binding yarn at stitching points on either side of the functional flexible element along the functional flexible element while retaining the functional flexible element on the flexible support, the at least one second binding yarn being stitched into the flexible support at the stitching points to a depth of less than the thickness of the flexible support.

3. The process as claimed in claim 2, wherein the stitching points of the at least one second binding yarn are located so that a stitching point of the at least one first binding yarn on one side of the functional flexible element is located between two stitching points of the at least one second binding yarn on the same side of the functional flexible element, without counting a first and last stitching point of the at least one second binding yarn.

4. The process as claimed in claim 2, wherein the at least one first binding yarn and the at least one second binding yarn are stitched at a first distance relative to a first edge of the functional flexible element and at a second distance relative to a second edge of the functional flexible element.

5. The process as claimed in claim 1, wherein the step of stitching along the first zigzag line is carried out with a single first binding yarn.

6. The process as claimed in claim 1, wherein the step of stitching along the first zigzag line is carried out with a plurality of first binding yarns, the first zigzag line being formed of segments, a first binding yarn forming one segment being different from another first binding yarn forming an adjacent segment having a stitching point in common.

7. The process as claimed in claim 2, wherein the supplementary step of stitching along the second zigzag line is carried out with a single second binding yarn.

8. The process as claimed in claim 2, wherein the supplementary step of stitching along the second zigzag line is carried out with a plurality of second binding yarns, the second zigzag line being formed of segments, a second binding yarn forming one segment being different from another second binding yarn forming an adjacent segment having a stitching point in common.

9. The process as claimed in claim 2, further comprising a step of joining the at least one first binding yarn and the at least one second binding yarn that comprises joining the at least one first binding yarn and the at least one second binding yarn to the flexible support by polymerization or by melting.

10. A system for fastening a functional flexible element to a flexible support using the process as claimed in claim 1, the functional flexible element having an elongated shape with a width smaller than a length, the flexible support having a thickness,
wherein the system comprises:
a first device for stitching at least one first binding yarn, the first stitching device comprising a needle comprising an eye through which the least one first binding yarn is able to pass,
a movement module for moving the needle configured to move and stitch the needle,
a control device configured to control the movement module so that the movement module stitches the needle into the flexible support along a first zigzag line of at least one binding yarn on either side of the functional flexible element along the functional flexible element while retaining the functional flexible element on the flexible support, to a depth of less than a thickness of the flexible support.

11. The system as claimed in claim 10, wherein the movement module comprises:
a sub-module for lowering the needle, configured to stitch the needle into the flexible support at a first stitching point to a depth of less than the thickness of the flexible support,
a sub-module for raising the needle, configured to raise the needle after having stitched the at least one first binding yarn into the flexible support,
a sub-module for translation of the needle, configured to convey the needle from the first stitching point to a second stitching point in order to form a zigzag segment.

12. The system as claimed in claim 10, wherein the movement module further comprises a rotational sub-module configured to rotate the needle about a predetermined angle of rotation around its longitudinal axis after the sub-module for raising the needle has raised the needle, the predetermined angle of rotation being substantially equal to an angle that corresponds to an angle between two successive zigzag segments having a stitching point in common.

13. The system as claimed in claim 10, further comprising a second device for stitching at least one second binding yarn that is identical to the first stitching device.
